(19) United States
(12) Patent Application Publication
(10) Pub. No.: US 2024/0006808 A1
(43) Pub. Date: Jan. 4, 2024

(54) CONNECTOR

(71) Applicant: SUMITOMO WIRING SYSTEMS, LTD., Mie (JP)

(72) Inventors: Toshihiro ITO, Mie (JP); Yoichi TAKAGI, Mie (JP)

(21) Appl. No.: 18/038,809

(22) PCT Filed: Nov. 19, 2021
(86) PCT No.: PCT/JP2021/042530

§ 371 Date: May 25, 2023

(30) Foreign Application Priority Data
Dec. 9, 2020 (JP) 2020-203977

(51) Int. Cl. H01R 13/627

(52) U.S. Cl. CPC H01R 13/6272

(57) ABSTRACT

A connector is connectable to a mating connector in a front-rear direction and provided with a housing. An upper wall portion of the housing is provided with a lock arm long in the front-rear direction and coupled to the upper wall portion. A pair of protection walls are provided to extend upward from the upper wall portion on both end parts in a lateral direction of a rear part of the upper wall portion. An operating portion to be pressed to deflect and deform the lock arm downward is provided on an upper side of a rear part of the lock arm. A right end part of the operating portion projects further rightward than a right end part of the lock arm and a left end part of the operating portion projects further leftward than a left end part of the lock arm.

### TECHNICAL FIELD

The present disclosure relates to a connector.

### BACKGROUND

Conventionally, a connector described in Japanese Patent Laid-open Publication No. 2000-182708 (Patent Document 1 below) is known. This connector includes a cantilevered lock arm extending in a front-rear direction on the upper surface of a housing body. The lock arm holds both housings in a connected state at the time of a connecting operation of the connectors. In separating the both housings, the holding in the connected state can be released by deflecting the lock arm downward. Further, wall-like ribs are provided to sandwich the lock arm on both left and right sides of the lock arm. The ribs protect the lock arm and suppress the entrance of external matters into a space between the lock arm and the upper surface of the housing body.

### PRIOR ART DOCUMENT

### Patent Document

Patent Document 1: JP 2000-182708 A

### SUMMARY OF THE INVENTION

### Problems to be Solved

However, due to the above configuration, the lock arm may become small and operability in releasing the connection of the connector may be impaired when the connector is miniaturized. Further, if the connector is miniaturized, intervals between the lock arm and the ribs also become narrower. Thus, the connector has to be manufactured using mold parts having an elongated shape to provide gaps between the lock arm and the ribs, and it becomes difficult to ensure the strength of the mold parts.

### Means to Solve the Problem

A connector of the present disclosure is connectable to a mating connector in a front-rear direction and provided with a housing, an upper wall portion of the housing being provided with a lock arm long in the front-rear direction and coupled to the upper wall portion, a pair of protection walls being provided to extend upward from the upper wall portion on both end parts in a lateral direction of a rear part of the upper wall portion, an operating portion to be pressed to deflect and deform the lock arm downward being provided on an upper side of a rear part of the lock arm, a right end part of the operating portion projecting further rightward than a right end part of the lock arm and a left end part of the operating portion projecting further leftward than a left end part of the lock arm, and a lower end part of the operating portion being disposed at the same height position as upper end parts of the pair of protection walls or at a position higher than the upper end parts.

### Effect of the Invention

According to the present disclosure, it is possible to provide a connector excellent in operability of connection release and easily manufacturable even if the connector is miniaturized.

### BRIEF DESCRIPTION OF THE DRAWINGS

FIG. 1 is a perspective view of a connector according to one embodiment.

FIG. 2 is a plan view of the connector.

FIG. 3 is a side view of the connector.

FIG. 4 is a back view of the connector.

FIG. 5 is a section along A-A of FIG. 2.

FIG. 6 is a section along B-B of FIG. 2.

FIG. 7 is a view showing a state before the connection of the connector and a mating connector in a cross-section along B-B of FIG. 2.

FIG. 8 is a view showing a connected state of the connector and the mating connector in the cross-section along B-B of FIG. 2.

### DETAILED DESCRIPTION TO EXECUTE THE INVENTION

### Description of Embodiments of Present Disclosure

First, embodiments of the present disclosure are listed and described.
(1) The connector of the present disclosure is connectable to a mating connector in a front-rear direction and provided with a housing, an upper wall portion of the housing being provided with a lock arm long in the front-rear direction and coupled to the upper wall portion, a pair of protection walls being provided to extend upward from the upper wall portion on both end parts in a lateral direction of a rear part of the upper wall portion, an operating portion to be pressed to deflect and deform the lock arm downward being provided on an upper side of a rear part of the lock arm, a right end part of the operating portion projecting further rightward than a right end part of the lock arm and a left end part of the operating portion projecting further leftward than a left end part of the lock arm, and a lower end part of the operating portion being disposed at the same height position as upper end parts of the pair of protection walls or at a position higher than the upper end parts.

According to this configuration, even if the connector is minimized, the size of the operating portion can be ensured and a connection releasing operation of the connector and the mating connector is easily performed. Further, it is not necessary to narrow intervals between the pair of protection walls and the lock arm, and the strength of mold parts used in manufacturing the connector can be ensured.
(2) Preferably, a rear end part of the lock arm and rear end parts of the pair of protection walls are coupled by a pair of coupling portions.

According to this configuration, a reaction force of the deflection and deformation of the lock arm can be improved and a connected state of the connector and the mating connector is easily maintained.
(3) Preferably, a rear end part of the operating portion is disposed at the same position as a rear end part of the lock arm in the front-rear direction.

According to this configuration, the operating portion can be made larger and the connection releasing operation is easily performed.
(4) Preferably, a front end part of the operating portion is disposed forward of front end parts of the pair of protection walls, and inclined portions inclined to reduce a height from the upper wall portion toward a front side are provided on front parts of the pair of protection walls.

According to this configuration, since the lock arm can be deflected and deformed by pushing down the operating portion along the inclined portions, the connection releasing operation is easily performed. Further, excessive deflection and deformation of the lock arm can be suppressed.
(5) Preferably, the housing includes a pair of side wall portions disposed on both left and right sides of the upper wall portion, and the pair of side wall portions include recesses set to have a thinner wall thickness and formed by being recessed inwardly of the housing.

According to this configuration, the amount of synthetic resin used in the connector can be reduced, and the formation of voids during molding can be suppressed.
(6) Preferably, a through hole penetrating in the front-rear direction is provided in a front end part of the lock arm.

According to this configuration, the amount of synthetic resin used in the connector can be reduced, and the formation of voids during molding can be suppressed.
(7) Preferably, the housing includes a pair of side wall portions disposed on both left and right sides of the upper wall portion, one of the pair of protection walls is a first protection wall and the other is a second protection wall, out of the pair of side wall portions, the side wall portion located on the side of the first protection wall is a first side wall portion and the side wall portion located on the side of the second protection wall is a second side wall portion, a projection dimension of the first protection wall from the first side wall portion is larger than a projection dimension of the second protection wall from the second side wall portion, and the first protection wall and the first side wall portion are coupled by a reinforcing wall portion.

According to this configuration, even if the connector is minimized, the size of the operating portion is easily ensured. Further, the strength of the first protection wall can be improved by the reinforcing wall portion.

### DETAILS OF EMBODIMENT OF PRESENT DISCLOSURE

Hereinafter, one embodiment of the present disclosure is described. The present disclosure is not limited to these illustrations, but is represented by claims and intended to include all changes in the scope of claims and in the meaning and scope of equivalents.

### Embodiment

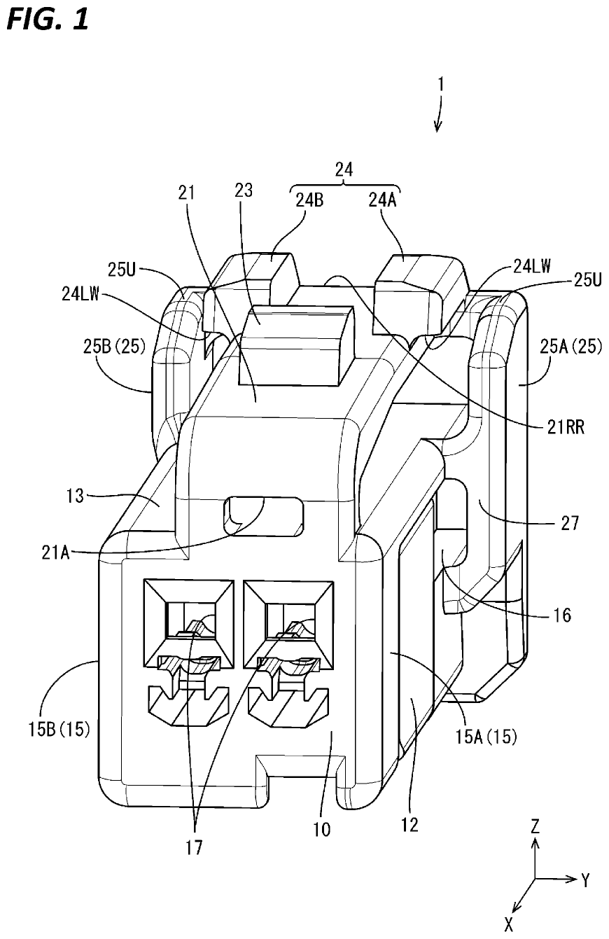

The embodiment of the present disclosure is described with reference to FIGS. 1 to 8. In the following description, a direction indicated by an arrow Z is referred to as an upward direction, a direction indicated by an arrow X is referred to as a forward direction and a direction indicated by an arrow Y is referred to as a leftward direction. Note that, for a plurality of identical members, only some may be denoted by a reference sign and the other members may not be denoted by the reference sign.

[Connector, Mating Connector]

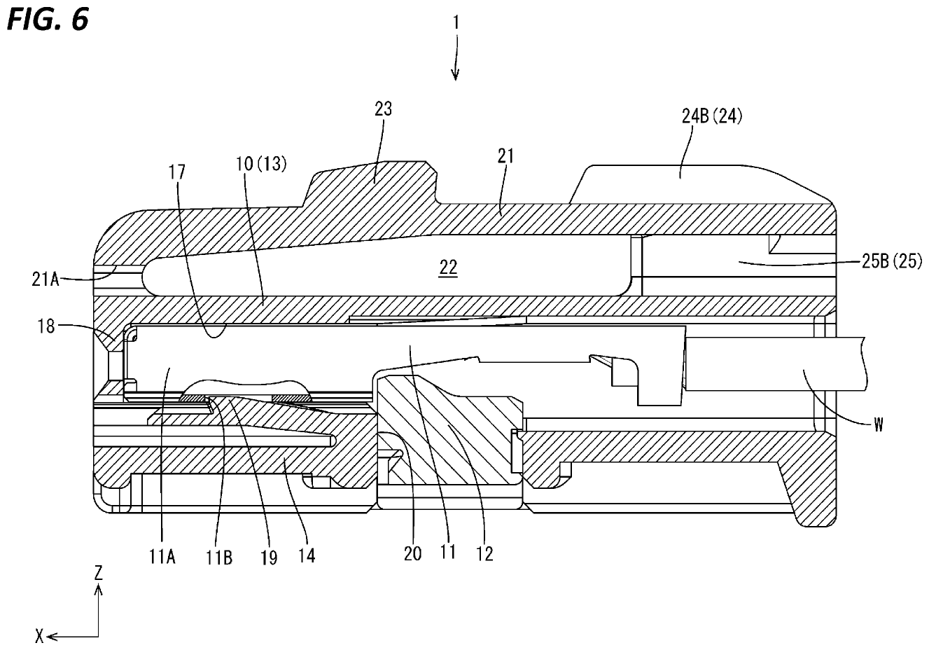

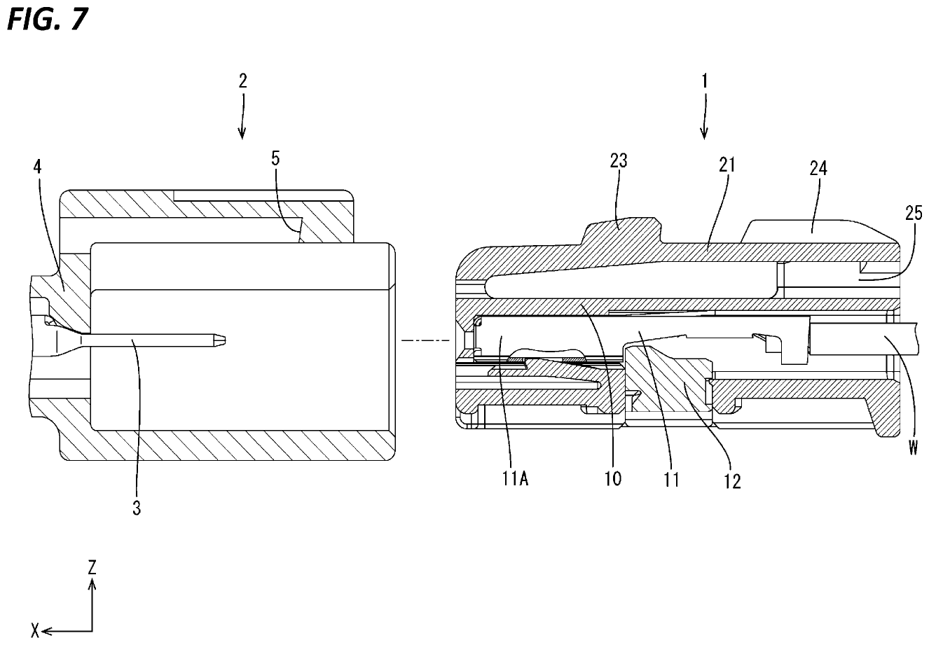

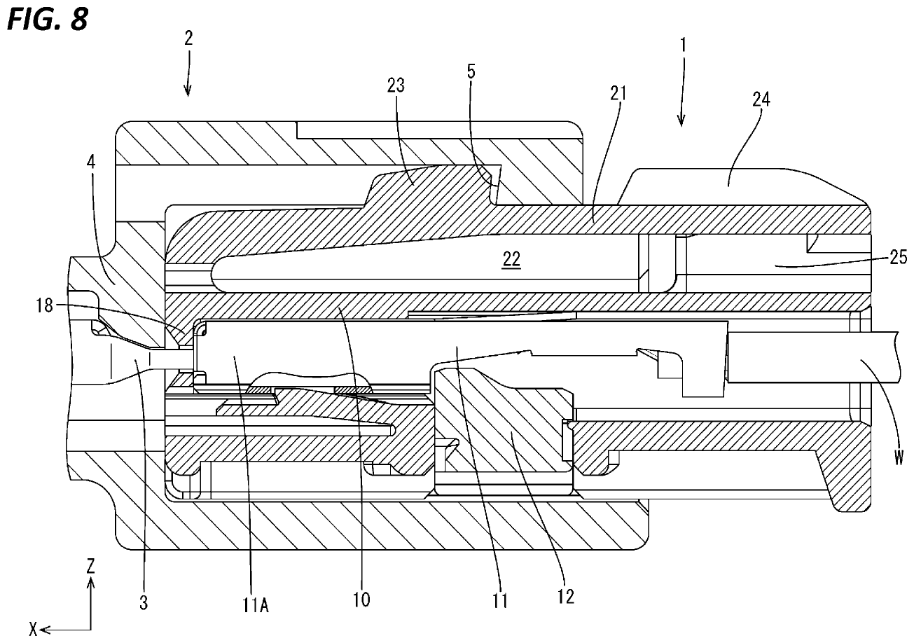

A connector 1 of this embodiment is, as shown in FIG. 6, provided with female terminals 11 connected to wires W extending rearward, a housing 10 for accommodating the female terminals 11 and a retainer 12 for preventing the female terminals 11 from coming out from the housing 10. Note that the female terminals 11 and the wires W are shown only in FIGS. 6 to 8. As shown in FIGS. 7 and 8, the connector 1 is connected to a mating connector 2 disposed in front. The mating connector 2 is provided with male terminals 3 and a mating housing 4 for accommodating the male terminals 3.

[Housing, Upper Wall Portion, Pair of Side Wall Portions]

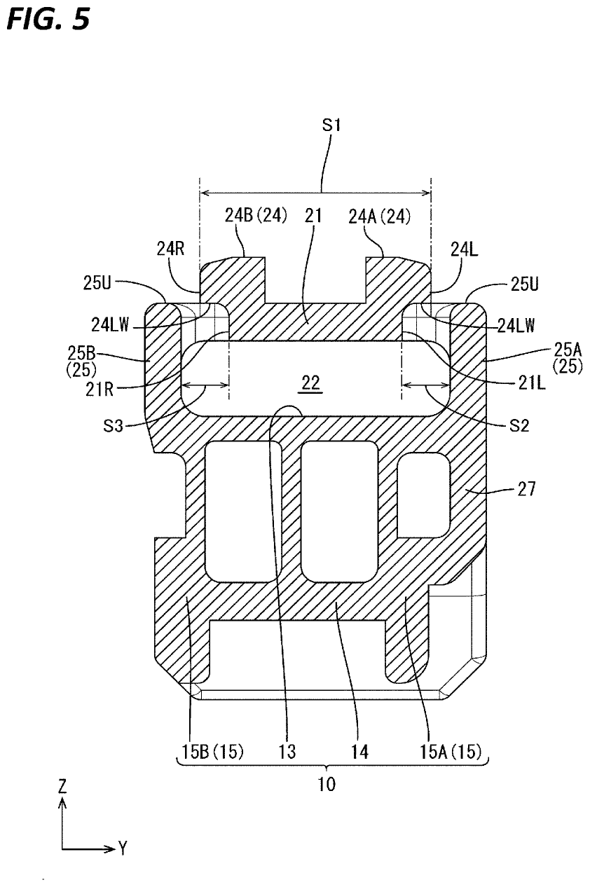

The housing 10 is made of insulating synthetic resin and has, as shown in FIG. 1, a rectangular parallelepiped shape elongated in a front-rear direction. As shown in FIG. 5, the housing 10 includes an upper wall portion 13 constituting an upper part of the housing 10, a lower wall portion 14 constituting a lower part of the housing 10 and a pair of side wall portions 15 disposed on both left and right sides of the upper and lower wall portions 13, 14 and connecting the upper and lower wall portions 13, 14. Here, the pair of side wall portions 15 are composed of a first side wall portion 15A and a second side wall portion 15B (described in detail later).

[Recesses]

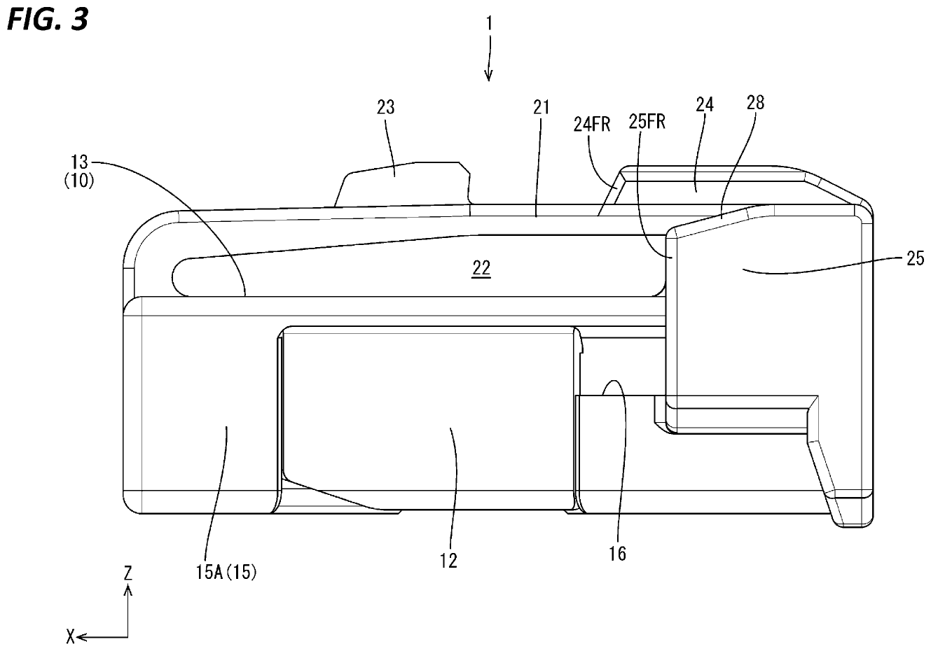

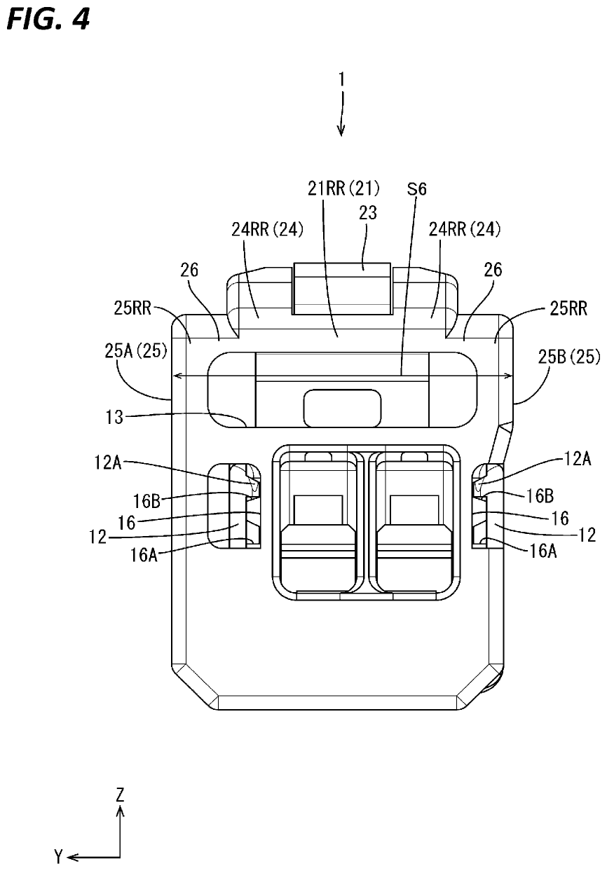

As shown in FIGS. 1 and 3, the pair of side wall portions 15 are provided with recesses 16 set to have a thinner wall thickness and formed by being recessed inwardly of the housing 10. The recesses 16 are partially covered by the retainer 12 in a central part in the front-rear direction of the housing 10. As shown in FIG. 4, a temporary locking portion 16A and a complete locking portion 16B for locking the retainer 12 are provided in the recess 16.

As shown in FIG. 1, two female terminal accommodating portions 17 open in the front-rear direction and arranged in parallel in a lateral direction are provided inside the housing 10. As shown in FIG. 6, the female terminal accommodating portion 17 is formed to be able to accommodate the female terminal 11. A connecting tube portion 11A of the female terminal 11 to be connected to the male terminal 3 is disposed on a front side of the female terminal accommodating portion 17 (see FIG. 8). A front wall portion 18 to be contacted by a front end part of the female terminal 11 is provided in a front end part of the female terminal accommodating portion 17. The wire W connected to the female terminal 11 is pulled out rearward from the female terminal accommodating portion 17. A locking lance 19 is provided to be deflectable and deformable in a vertical direction on the side of the lower wall portion 14 of the front side of the female terminal accommodating portion 17. The locking lance 19 is resiliently locked to a lance receiving portion 11B provided in the connecting tube portion 11A.

As shown in FIG. 6, a retainer insertion hole 20, into which the retainer 12 is inserted, is provided on the side of the lower wall portion 14 of a central part in the front-rear direction of the female terminal accommodating portion 17. The retainer 12 can be locked to the housing 10 at a temporary locking position (not shown) and a complete locking position (see FIGS. 4 and 6). That is, in FIG. 4, locking projections 12A of the retainer 12 are locked to the temporary locking portions 16A at the temporary locking position and locked to the complete locking portions 16B at the complete locking position. The female terminals 11 are enabled to be inserted into the female terminal accommodating portions 17 when the retainer 12 is at the temporary locking position, whereas the female terminals 11 are prevented from coming out rearward from the female terminal accommodating portions 17 when the retainer 12 is at the complete locking position (see FIG. 6).

[Lock Arm, Through Hole]

As shown in FIGS. 1 and 3, the upper wall portion 13 of the housing 10 is provided with a lock arm 21 extending in the front-rear direction. The lock arm 21 is supported on both sides and a front end part of the lock arm 21 is connected to a front side of the upper wall portion 13. As shown in FIGS. 1 and 4, a rear end part 21RR of the lock arm 21 is coupled to a pair of protection walls 25 to be described later. The lock arm 21 is mainly configured such that a central part in the front-rear direction of the lock arm 21 is deflectable and deformable in the vertical direction. As shown in FIG. 3, a space between the lock arm 21 and the upper wall portion 13 serves as a resilient deformation region 22 where the lock arm 21 is deflectable and deformable. As shown in FIG. 1, a through hole 21A penetrating in the front-rear direction is provided in the front end part of the lock arm 21.

[Operating Portion]

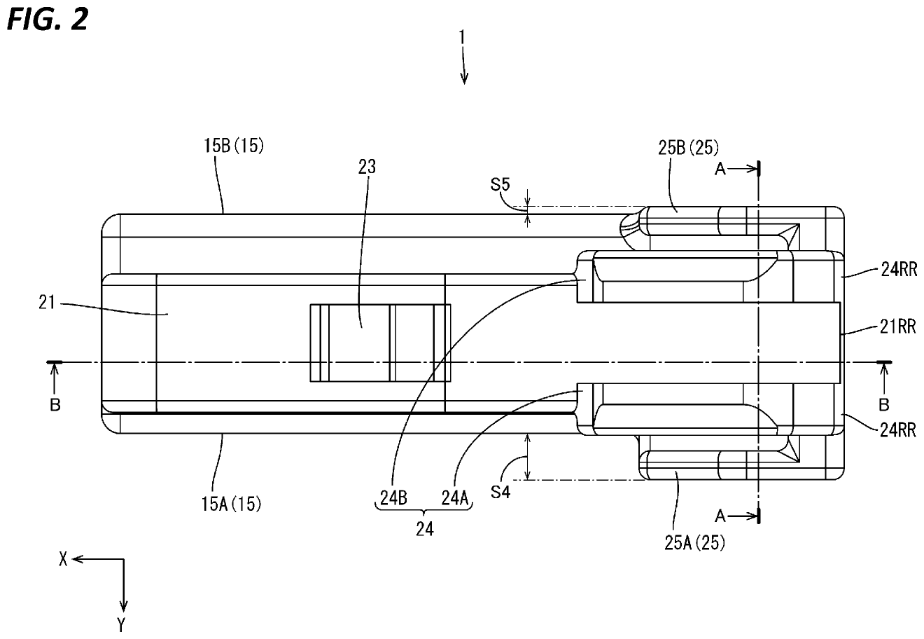

As shown in FIGS. 1 to 3, a lock portion 23 projecting upward is provided in the central part in the front-rear direction of the lock arm 21. An operating portion 24 is provided on an upper side of a rear part of the lock arm 21. As shown in FIG. 8, the lock portion 23 is locked to a lock receiving portion 5 provided in the mating housing 4 of the mating connector 2. The connected state of the connector 1 and the mating connector 2 is maintained by the locking of the lock portion 23 and the lock receiving portion 5. The operating portion 24 is a member to be pressed to deflect and deform the lock arm 21 downward, and is used to release the locking of the lock portion 23 and the lock receiving portion 5 and release the connection of the connector 1 and the mating connector 2 for separation. Note that, as shown in FIGS. 1 and 2, the operating portion 24 of this embodiment is composed of a first operating portion 24A and a second operating portion 24B configured not to be located behind the lock portion 23 to form the lock portion 23, the first operating portion 24A is disposed on the left side of the lock arm 21 and the second operating portion 24B is disposed on the right side of the lock arm 21.

As shown in FIG. 5, a right end part 24R of the operating portion 24 projects further rightward than a right end part 21R of the lock arm 21 and a left end part 24L of the operating portion 24 projects further leftward than a left end part 21L of the lock arm 21. As shown in FIG. 2, rear end parts 24RR of the operating portion 24 are disposed at the same position as a rear end part 21RR of the lock arms 21 in the front-rear direction. By expanding the operating portion 24 further than the lock arm 21 in the lateral direction and aligning the respective rear end parts 24RR, 21RR in this way, it is possible to provide the operating portion 24 having a sufficient size for a connection releasing operation even if the connector 1 is minimized

[Pair of Protection Walls, Pair of Coupling Portions]

As shown in FIGS. 1 and 4, the pair of protection walls 25 are provided to extend upward from the upper wall portion 13 on both end parts in the lateral direction of a rear part of the upper wall portion 13. As shown in FIG. 4, the rear end part 21RR of the lock arm 21 and rear end parts 25RR of the pair of protection walls 25 are coupled by a pair of coupling portions 26. The pair of coupling portions 26 connect both end parts in the lateral direction of the lock portion 21 and upper parts of the pair of protection walls 25. As shown in FIG. 5, the pair of protection walls 25 are arranged to cover a rear side of the resilient deformation region 22 from the lateral direction. As shown in FIG. 8, with the connector 1 and the mating connector 2 connected, most of the resilient deformation region 22 is covered by the mating housing 4 and the pair of protection walls 25. In this way, it can be suppressed that external matters (e.g. a wire, a terminal and the like) enter the resilient deformation region 22 to hinder the connection releasing operation.

[Lower End Part of Operating Portion, Upper End parts of Pair of Protection Walls]

As shown in FIG. 5, in this embodiment, lower end parts 24LW of the operating portion 24 are disposed at the same height position as upper end parts 25U of the pair of protection walls 25. That is, the operating portion 24 and the pair of protection walls 25 are shifted in a height direction and do not interfere with each other in the lateral direction. According to this arrangement, even if a dimension S1 in the lateral direction of the operating portion 24 is increased, intervals S2, S3 in the lateral direction between the pair of protection walls 25 and the lock arm 21 need not be narrowed. Therefore, it is possible to ensure the strength of mold parts for forming spaces (regions shown by the intervals S2, S3) between the lock arm 21 and the pair of protection walls 25.

[First Protection Wall, Second Protection Wall, First Side Wall Portion, Second Side Wall Portion]

As shown in FIG. 1, the pair of protection walls 25 include a first protection wall 25A and a second protection wall 25B. Out of the pair of side wall portions 15, the one located on the side of the first protection wall 25A (left side in this embodiment) is the first side wall portion 15A and the one located on the side of the second protection wall 25B (right side in this embodiment) is the second side wall portion 15B. The first and second protection walls 25A, 25B are respectively provided to project more outward from the housing 10 than the first and second side wall portions 15A, 15B. Here, as shown in FIG. 2, a projection dimension S4 of the first protection wall 25A from the first side wall portion 15A is larger than a projection dimension S5 of the second protection wall 25B from the second side wall portion 15B.

[Reinforcing Wall Portion]

As shown in FIGS. 1 and 5, the first protection wall 25A and the first side wall portion 15A are coupled by a reinforcing wall portion 27. The reinforcing wall portion 27 is bent rightward and connected to the first side wall portion 15A after extending downward from a lower end part of the first protection wall 25A.

By causing the pair of protection walls 25 to project outward with respect to the housing 10 as described above, the size of the operating portion 24 is easily ensured even if the connector 1 is minimized Note that it is also considered to cause the pair of protection walls to project outward as much as the pair of side wall portions as an embodiment different from this embodiment. However, since the projection dimension S5 of the second protection wall 25B can be reduced in this embodiment, a reduction in the strength of the second protection wall 25B can be suppressed. On the other hand, there is a concern of a strength reduction for the first protection wall 25A largely projecting outward, but the strength of the first protection wall 25A is improved by coupling the first protection wall 25A and the first side wall portion 15A by the reinforcing wall portion 27. Thus, in this embodiment, the operating portion 24 can be made larger while a reduction in the strength of the pair of protection walls 25 is suppressed.

Further, in this embodiment, the pair of protection walls 25 are asymmetrically arranged with respect to the housing 10. For example, in the case of considering the optimization of a connector arrangement space and operability in connection and separation, it may not be possible to symmetrically arrange a pair of protection walls. However, according to this embodiment, such a case can also be dealt with.

[Inclined Portions]

As shown in FIG. 3, front end parts 24FR of the operating portion 24 are disposed forward of front end parts 25FR of the pair of protection walls 25. Inclined portions 28 inclined to reduce a height from the upper wall portion 13 toward a front side are provided on front parts of the pair of protection walls 25. According to the above configuration, since the lock arm 21 can be deflected and deformed by pushing down the operating portion 24 along the inclined portions 28 particularly such as when an interval S6 (see FIG. 4) between the pair of protection walls 25 is smaller than a worker's finger thickness, the connection releasing operation is easily performed. Further, by properly setting the heights of the inclined portions 28 from the upper wall portion 13, excessive deflection and deformation of the lock arm 21 can be suppressed.

### Functions and Effects of Embodiment

According to this embodiment, the following functions and effects are achieved. The connector 1 according to this embodiment is connectable to the mating connector 2 in the front-rear direction and provided with the housing 10, the upper wall portion 13 of the housing 10 is provided with the lock arm 21 long in the front-rear direction and coupled to the upper wall portion 13, the pair of protection walls 25 are provided to extend upward from the upper wall portion 13 on the both end parts in the lateral direction of the rear part of the upper wall portion 13, the operating portion 24 to be pressed to deflect and deform the lock arm 21 downward is provided on the upper side of the rear part of the lock arm 21, the right end part 24R of the operating portion 24 projects further rightward than the right end part 21R of the lock arm 21 and the left end part 24L of the operating portion 24 projects further leftward than the left end part 21L of the lock arm 21, and the lower end parts 24LW of the operating portion 24 are disposed at the same height position as the upper end parts 25U of the pair of protection walls 25.

According to the above configuration, even if the connector 1 is miniaturized, the size of the operating portion 24 can be ensured and the connection releasing operation of the connector 1 and the mating connector 2 is easily performed. Further, the intervals S2, S3 between the pair of protection walls 25 and the lock arm 21 need not be narrowed and the strength of the mold parts used in manufacturing the connector 1 can be ensured.

In this embodiment, the rear end part 21RR of the lock arm 21 and the rear end parts 25RR of the pair of protection walls 25 are coupled by the pair of coupling portions 26.

According to the above configuration, a reaction force of the deflection and deformation of the lock arm 21 can be improved and the connected state of the connector 1 and the mating connector 2 is easily maintained.

In this embodiment, the rear end parts 24RR of the operating portion 24 are disposed at the same position as the rear end part 21RR of the lock arm 21 in the front-rear direction.

According to the above configuration, the operating portion 24 can be made larger and the connection releasing operation is easily performed.

In this embodiment, the front end parts 24FR of the operating portion 24 are disposed forward of the front end parts 25FR of the pair of protection walls 25, and the inclined portions 28 inclined to reduce the height from the upper wall portion 13 toward the front side are provided on the front parts of the pair of protection walls 25.

According to the above configuration, since the lock arm 21 can be deflected and deformed by pushing down the operating portion 24 along the inclined portions 28, the connection releasing operation is easily performed. Further, excessive deflection and deformation of the lock arm 21 can be suppressed.

In this embodiment, the housing 10 includes the pair of side wall portions 15 disposed on both left and right sides of the upper wall portion 13, and the pair of side wall portions 15 include the recesses 16 set to have a thinner wall thickness and formed by being recessed inwardly of the housing 10.

According to the above configuration, the amount of synthetic resin used in the connector 1 can be reduced, and the formation of voids during molding can be suppressed.

In this embodiment, the through hole 21A penetrating in the front-rear direction is provided in the front end part of the lock arm 21.

According to the above configuration, the amount of synthetic resin used in the connector 1 can be reduced, and the formation of voids during molding can be suppressed.

In this embodiment, one of the pair of protection walls 25 is the first protection wall 25A and the other is the second protection wall 25B, the side wall portion 15 located on the side of the first protection wall 25A, out of the pair of side wall portions is the first side wall portion 15A and the side wall portion 15 located on the side of the second protection wall 25B is the second side wall portion 15B, the projection dimension S4 of the first protection wall 25A from the first side wall portion 15A is larger than the projection dimension S5 of the second protection wall 25B from the second side wall portion 15B, and the first protection wall 25A and the first side wall portion 15A are coupled by the reinforcing wall portion 27.

According to the above configuration, the size of the operating portion 24 is easily ensured even if the connector 1 is miniaturized. Further, the strength of the first protection wall 25A can be improved by the reinforcing wall portion 27.

### OTHER EMBODIMENTS

(1) Although the connector 1 includes the retainer 12 in the above embodiment, there is no limitation to this and a connector may not include a retainer.
(2) Although the lower end parts 24LW of the operating portion 24 are disposed at the same height position as the upper end parts 25U of the pair of protection walls 25, there is no limitation to this and lower end parts of an operating portion may be disposed at a position higher than upper end parts of a pair of protection walls.
(3) Although the rear end part 21RR of the lock arm 21 and the rear end parts of the pair of protection walls 25 are coupled by the pair of coupling portions 26 in the above embodiment, there is no limitation to this and a rear end part of a lock arm may be connected to a rear end part of an upper wall portion without being coupled to rear end parts of a pair of protection walls.
(4) Although the lock arm 21 is supported on both sides and connected to the front side of the upper wall portion 13 and the pair of protection walls 25 in the above embodiment, there is no limitation to this and a lock arm may be cantilevered and connected only to a front side of an upper wall portion.
(5) Although the projection dimension S4 of the first protection wall 25A from the first side wall portion 15A is larger than the projection dimension S5 of the second protection wall 25B from the second side wall portion 15B and the first protection wall and the first side wall portion 15A are coupled by the reinforcing wall portion 27 in the above embodiment, there is no limitation to this. For example, projection dimensions of a pair of protection walls from a pair of side wall portions may be equal.
(6) Although the operating portion 24 is composed of the first operating portion 24A and the second operating portion 25B in the above embodiment, there is no limitation to this and an operating portion may be integrally provided without being divided into left and right parts.

### LIST OF REFERENCE NUMERALS

1: connector
2: mating connector
3: male terminal
4: mating housing
5: lock receiving portion
10: housing
11: female terminal
11A: connecting tube portion
11B: lance receiving portion
12: retainer
12A: locking projection
13: upper wall portion
14: lower wall portion
15: pair of side wall portions
15A: first side wall portion
15B: second side wall portion
16: recess
16A: temporary locking portion
16B: complete locking portion
17: female terminal accommodating portion
18: front wall portion
19: locking lance
20: retainer insertion hole
21: lock arm
21A: through hole
21L: left end part of lock arm
21R: right end part of lock arm
21RR: rear end part of lock arm
22: resilient deformation region
23: lock portion
24: operating portion
24A: first operating portion
24B: second operating portion
24FR: front end part of operating portion
24L: left end part of operating portion
24LW: lower end part of operating portion
24R: right end part of operating portion
24RR: rear end part of operating portion
25: pair of protection walls
25A: first protection wall
25B: second protection wall
25FR: front end parts of pair of protection walls
25RR: rear end parts of pair of protection walls
25U: upper end parts of pair of protection walls
26: pair of coupling portions
27: reinforcing wall portion
28: inclined portion
S1: dimension in lateral direction of operating portion
S2, S3: intervals between pair of protection walls and lock arm
S4: projection dimension of first protection wall from first side wall portion
S5: projection dimension of second protection wall from second side wall portion
S6: interval between pair of protection walls
W: wire

1. A connector connectable to a mating connector in a front-rear direction, comprising a housing,
an upper wall portion of the housing being provided with a lock arm long in the front-rear direction and coupled to the upper wall portion,
a pair of protection walls being provided to extend upward from the upper wall portion on both end parts in a lateral direction of a rear part of the upper wall portion,
an operating portion to be pressed to deflect and deform the lock arm downward being provided on an upper side of a rear part of the lock arm,
a right end part of the operating portion projecting further rightward than a right end part of the lock arm and a left end part of the operating portion projecting further leftward than a left end part of the lock arm, and
a lower end part of the operating portion being disposed at the same height position as upper end parts of the pair of protection walls or at a position higher than the upper end parts.

2. The connector of claim 1, wherein a rear end part of the lock arm and rear end parts of the pair of protection walls are coupled by a pair of coupling portions.

3. The connector of claim 1, wherein a rear end part of the operating portion is disposed at the same position as a rear end part of the lock arm in the front-rear direction.

4. The connector of claim 1, wherein:
a front end part of the operating portion is disposed forward of front end parts of the pair of protection walls, and
inclined portions inclined to reduce a height from the upper wall portion toward a front side are provided on front parts of the pair of protection walls.

5. The connector of claim 1, wherein:
the housing includes a pair of side wall portions disposed on both left and right sides of the upper wall portion, and
the pair of side wall portions include recesses set to have a thinner wall thickness and formed by being recessed inwardly of the housing.

6. The connector of claim 1, wherein a through hole penetrating in the front-rear direction is provided in a front end part of the lock arm.

7. The connector of claim 1, wherein:
the housing includes a pair of side wall portions disposed on both left and right sides of the upper wall portion,
one of the pair of protection walls is a first protection wall and the other is a second protection wall,
out of the pair of side wall portions, the side wall portion located on the side of the first protection wall is a first side wall portion and the side wall portion located on the side of the second protection wall is a second side wall portion,
a projection dimension of the first protection wall from the first side wall portion is larger than a projection dimension of the second protection wall from the second side wall portion, and
the first protection wall and the first side wall portion are coupled by a reinforcing wall portion.
